(19) United States
(12) Patent Application Publication
(10) Pub. No.: US 2026/0192373 A1
(43) Pub. Date: Jul. 9, 2026

(54) Precision Sliding Gutter Miter Saw Station

(71) Applicant: Brian Roelle, Portland, OR (US)

(72) Inventor: Brian Roelle, Portland, OR (US)

(21) Appl. No.: 19/009,942

(22) Filed: Jan. 4, 2025

(51) Int. Cl. B23D 45/04; B23D 47/02

(52) U.S. Cl. CPC B23D 45/048; B23D 47/025

(57) ABSTRACT

The Precision Sliding Gutter Miter Saw Station is a portable, durable platform designed to enhance the efficiency and accuracy of gutter installation. The station integrates with most gutter machines, aligning a miter saw for precise cutting. Featuring a linear rail system for controlled sliding and a protective coated frame, it minimizes material waste and reduces physical strain. Compatible with various miter saw models, it folds vertically for compact storage and is ideal for professional installers.

### BACKGROUND OF THE INVENTION

### Field of the Invention

This invention relates to the field of construction tools and equipment, specifically to a miter station designed to securely hold a miter chop saw in conjunction with a gutter machine to facilitate precise and efficient cutting of gutters and related components during installation.

### Description of Related Art

In the field of gutter installation, cutting precision is critical to ensure proper fit, structural integrity, and aesthetic appeal. Traditionally, installers have relied on aviation tin snips or improvised solutions to make cuts on gutters. These methods often lead to inconsistent results, reduced efficiency, and potential safety hazards due to unstable setups. Additionally, transporting and securely setting up tools at a job site poses challenges for installers.

Some existing products aim to address these issues by providing cutting stations or platforms; however, they often lack versatility, ease of use, or compatibility with various gutter machines. Furthermore, current solutions may require significant time and effort for setup or fail to accommodate the varying needs of professional gutter installers.

### Need for the Invention

There is a need for a reliable, portable station that integrates seamlessly with gutter machines, allowing installers to achieve accurate cuts with minimal effort or hand strain. The station should provide stability, precise sliding mechanisms, and ergonomic features to streamline the gutter cutting process, reduce material waste, and enhance overall productivity. The present invention addresses these shortcomings by introducing a Precision Sliding Gutter Miter Saw Station, a tool specifically designed to improve the workflow and outcomes for gutter installation professionals. Additionally, this invention reduces the risks associated with repetitive use of tin snips for long hours.

### SUMMARY OF THE INVENTION

The present invention is a Precision Sliding Gutter Miter Saw Station designed to enhance the efficiency and accuracy of gutter installation. The station integrates seamlessly with standard gutter machines, providing a stable, sliding carrier for securely attaching a miter saw. Its precision sliding mechanism allows for smooth, controlled movement during cutting, ensuring consistent and accurate results. This invention addresses the challenges of traditional gutter cutting methods by improving workflow, reducing material waste, and ensuring safety and precision, making it an indispensable tool for professional gutter installers.

### BRIEF DESCRIPTION OF THE DRAWINGS

FIG. 1A: Three separate perspective view of the Precision Sliding Gutter Miter Saw Station, showing the overall assembly and key components in their assembled state.

FIG. 1B: A detailed side view illustrating the station's alignment and sliding mechanism.

FIG. 1C: A sectional view (A-A) highlighting the internal structure of the linear rail system and its attachment points.

FIG. 1D: A view showing the individual components, quantity required, including the linear rail mounts, pivot arms, and saw mount, and how they fit together.

FIG. 1E: A detailed view of the mount ear and its dimensions.

FIG. 1F: A detailed view of the small mount hanger.

FIG. 1G: A detailed view of the angle brace.

FIG. 1H: A detailed view of the bearing blocks.

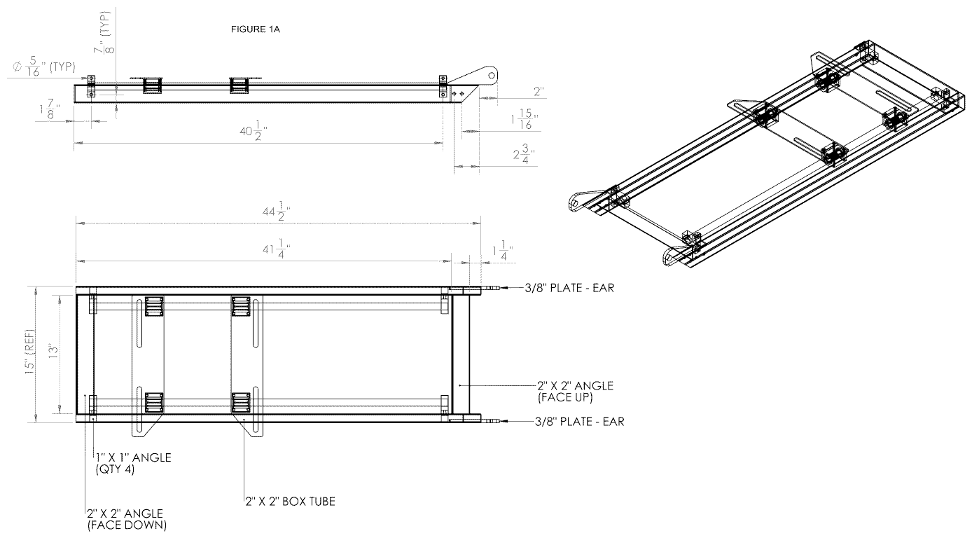

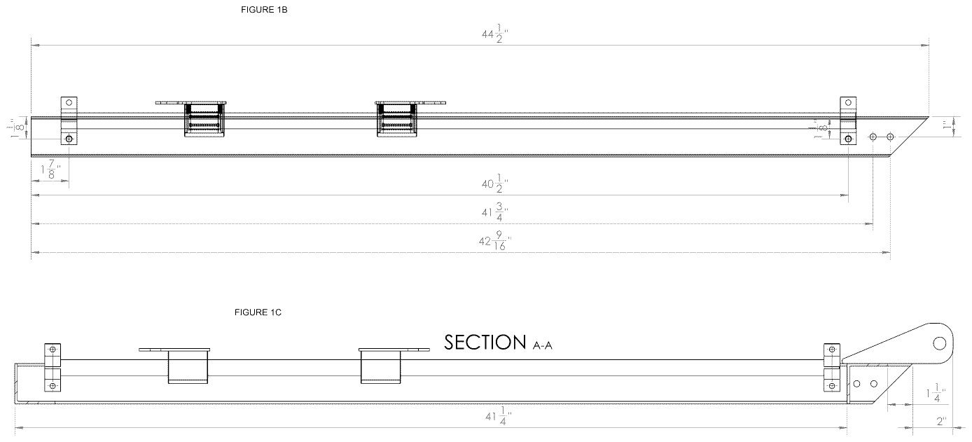

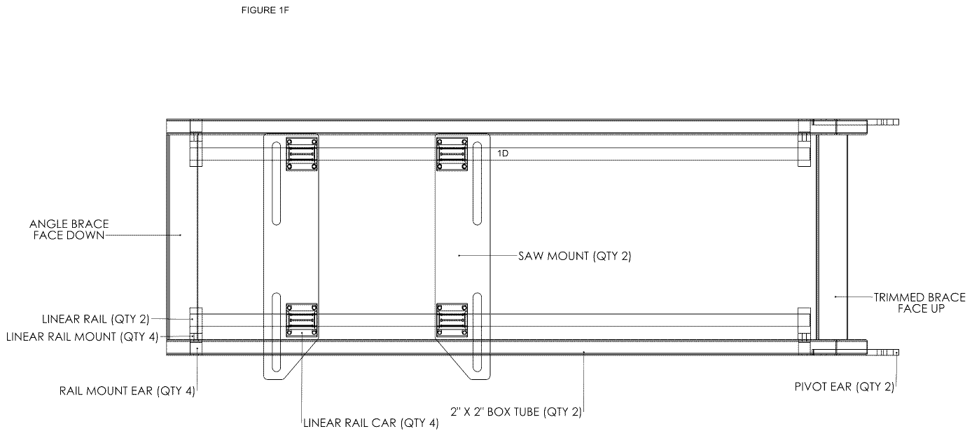

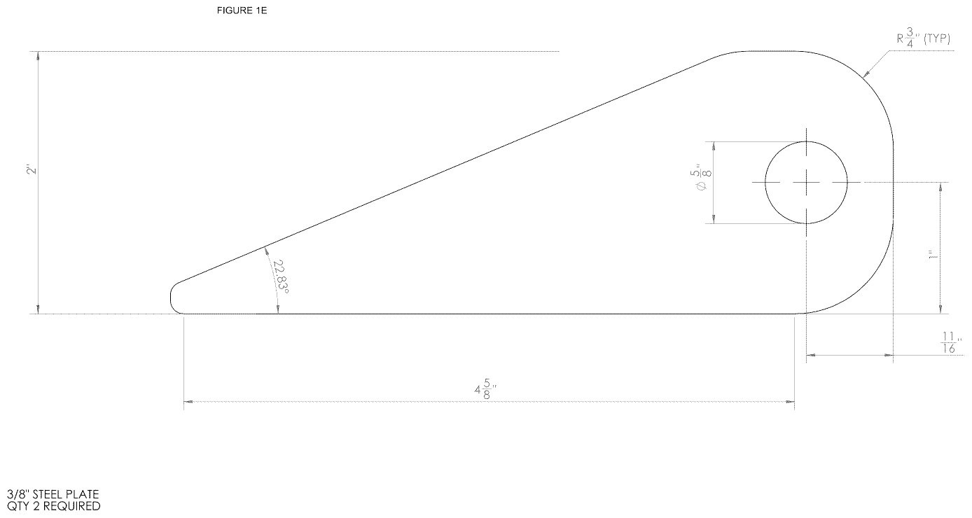

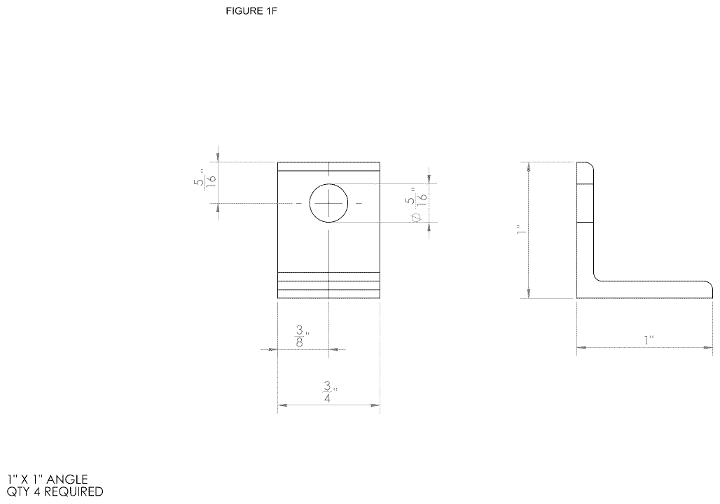

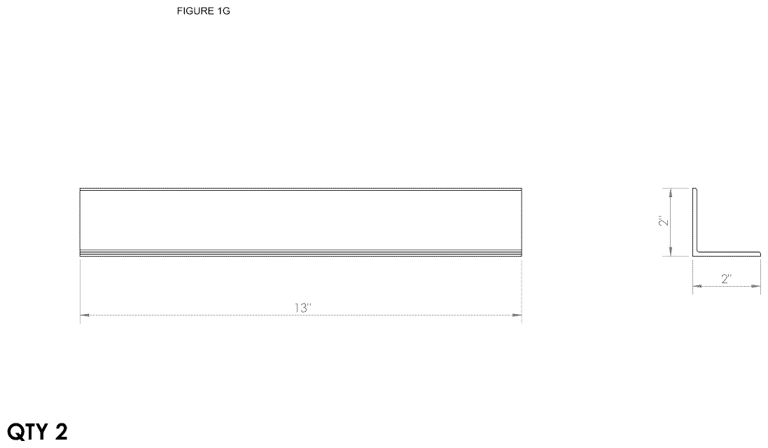

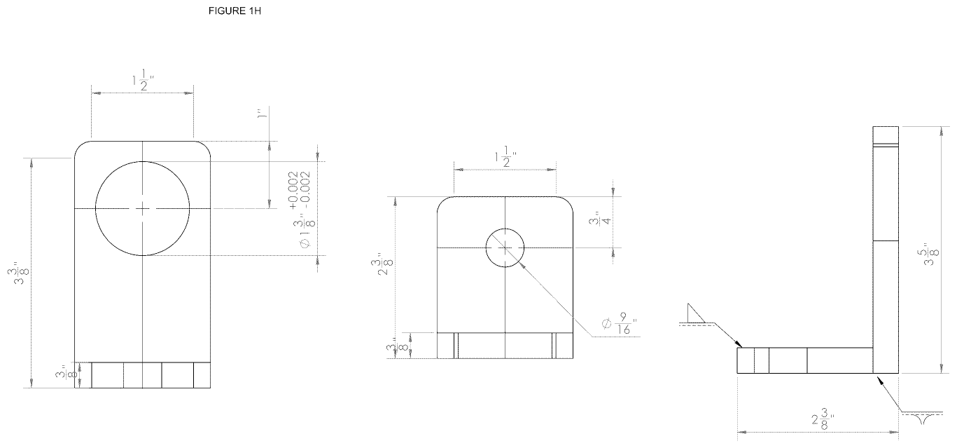

### DETAILED DESCRIPTION OF THE INVENTION

The Precision Sliding Gutter Miter Saw Station is a robust, precision-engineered cutting platform designed to streamline gutter installation by securely holding a miter saw in alignment with a gutter machine.

### Key Components and Features

A. Base Frame:
   Constructed from durable metal, such as steel or aluminum, the base frame provides a stable foundation for the station. It includes mounting brackets for secure attachment to the gutter machine, ensuring minimal vibration during cutting operations.
B. Linear Rail System:
   A precision linear rail system allows smooth and controlled sliding of the saw along the material to be cut. The rails are corrosion-resistant, ensuring durability in harsh job site conditions.
C. Saw Mounting Platform:
   The platform includes slotted holes for attaching various miter saw models and adjustable leveling bolts to align the saw with the gutter feed.
D. Stabilizing Brackets:
   Two L-shaped brackets and pivot arms securely attach the station to the gutter machine, providing stability during operation.
E. Protective Coating:
   The frame is coated with a protective finish, such as bed liner, powder coating, or paint, to resist corrosion and wear.
F. Portability:
   The station folds vertically for compact storage and locks securely in place during transport.
G. Optional Features:
   An optional rotational saw mount facilitates angled cuts, such as those required for downspouts.

1. A gutter miter station comprising:
A base frame configured to attach to a gutter machine for stability and alignment;
A linear rail system mounted on the base frame, allowing controlled sliding movement of a miter saw;
A saw mounting platform with slotted holes and leveling bolts for alignment with the gutter feed;
Stabilizing brackets and pivot arms for secure attachment;
A protective coating to prevent corrosion and wear; and
Corrosion-resistant hardware for long-term durability.

2. The gutter miter station of claim 1, wherein the linear rail system comprises:
Corrosion-resistant rails; and
A bearing block assembly to enable smooth and precise sliding motion.

3. The gutter miter station of claim 1, wherein the saw mounting platform is compatible with multiple miter saw models.

4. The gutter miter station of claim 1, further comprising a resistance-bearing system to reduce saw pull during miter cuts.

5. The gutter miter station of claim 1, wherein the station folds vertically and locks for transport.

6. A method of using the gutter miter station as described in claim 1, comprising:
Mounting the station to a gutter machine;
Attaching a miter saw to the mounting platform;
Sliding the saw along the rail system to make cuts; and
Folding the station for storage.
